(19) United States
(12) Patent Application Publication
(10) Pub. No.: US 2025/0150108 A1
(43) Pub. Date: May 8, 2025

(54) Power Backup Wi-Fi Router Device

(71) Applicant: Leroy Robinson, Apollo Beach, FL (US)

(72) Inventor: Leroy Robinson, Apollo Beach, FL (US)

(21) Appl. No.: 18/668,430

(22) Filed: May 20, 2024

Related U.S. Application Data
(60) Provisional application No. 63/596,747, filed on Nov. 7, 2023.

(51) Int. Cl. H04B 1/3883; H02J 9/06; H04W 84/12; H04W 88/08

(52) U.S. Cl. CPC H04B 1/3883; H02J 9/06; H04W 84/12; H04W 88/08

(57) ABSTRACT

A Wi-Fi router with an integrated backup battery is disclosed. The Wi-Fi router device is a Wi-Fi 6 router having a plurality of 4 Gigabit LAN ports, a 2.5G WAN port, and a plurality of antennas. The integrated backup battery is adapted to provide power to the router device for up to 12 hours without requiring any external power supply. The battery is recharged using the external power supply, when available, and in case of a power outage, the router device transitions from the external power supply to the backup battery. A LED indicates the status of the functionality of the router device. In some embodiments, the router device includes an integrated modem. The router device provides internet connectivity even during power outages such as during storms, inclement weather, and more.

### CROSS-REFERENCE TO RELATED APPLICATION

The present application claims priority to, and the benefit of, U.S. Provisional Application No. 63/596,747, which was filed on Nov. 7, 2023, and is incorporated herein by reference in its entirety.

### FIELD OF THE INVENTION

The present invention generally relates to the field of Wi-Fi router devices and modems. More specifically, the present invention relates to a novel Wi-Fi router device that includes a backup battery for operating the router device for up to 12 hours without requiring any external power supply. A 100-watt battery backup built into the Wi-Fi device to provide 10 to 12 hours of Wi-Fi availability without any external power supply. When an external power supply is available, then, the battery is recharged for further operation. Accordingly, the present disclosure makes specific reference thereto. Nonetheless, it is to be appreciated that aspects of the present invention are also equally applicable to other like applications, devices, and methods of manufacture.

### BACKGROUND

By way of background, a Wi-Fi router is a device that connects to an Internet Service Provider (ISP) and enables the distribution of the internet signal within a home or office. Specifically, the Wi-Fi router receives the internet signal from the ISP and creates a wireless network. Devices like laptops, smartphones, tablets, smart TVs, and other Wi-Fi-enabled devices connect to the internet wirelessly or use a wired connection with the Wi-Fi router. In some conventional devices, the modem and router can be two separate devices, while in others, they can be combined into one unit, often referred to as a gateway. All the conventional Wi-Fi router devices require electrical power to operate, which they receive through standard electrical plugs and outlets.

However, during a power outage, the electricity supply is not available and as a result, modems and routers relying upon external power supply stop functioning. The Wi-Fi network goes down, and the connected devices cannot connect to the internet through the Wi-Fi router device. The loss of internet connectivity can disrupt various activities like sending texts, making phone calls (if they rely on internet-based services), accessing emails, using social media, and other online functions. In businesses, loss of internet access can disrupt the work and affect productivity. Power outages are more prominent during storms, extreme snowfall, wind, rain, and more and can impact internet access for longer periods of time.

Commonly, cell phones are not dependent on home electricity (as they have their own batteries), but they might still face connectivity issues during a power outage. This is because cell phones usually switch to a cellular data network when Wi-Fi is unavailable. However, if many individuals in an area are accessing the cellular data network, the local cellular network can become congested, leading to reduced connectivity and slower internet speeds. Individuals desire an improved Wi-Fi router device that can function and provide Wi-Fi connectivity even during a power outage and without a supply of external electrical power.

Therefore, there exists a long-felt need in the art for an improved Wi-Fi router device. There is also a long-felt need in the art for a router device that includes a backup battery for operation of the router device. Additionally, there is a long-felt need in the art for a novel Wi-Fi router device that can provide Wi-Fi internet through standard power or a backup battery. Moreover, there is a long-felt need in the art for a novel Wi-Fi router that includes a backup battery which can be recharged using an external power supply. Furthermore, there is a long-felt need in the art for a Wi-Fi router device that includes an integrated battery to power the router device to maintain internet access. Also, there is a long-felt need in the art for a Wi-Fi router device that offers continuous Wi-Fi power, specifically during power outages. Finally, there is a long-felt need in the art for a Wi-Fi router device that features an internal battery backup that can maintain Wi-Fi access for up to 12 hours without requiring an external power supply.

The subject matter disclosed and claimed herein, in one embodiment thereof, comprises a Wi-Fi router device. The Wi-Fi router device includes an integrated backup battery, the integrated backup battery is capable of providing up to 12 hours of Wi-Fi power without requiring an external power supply, wherein the backup battery is adapted to recharge using an external power supply. When the external power supply is available, the backup battery is recharged and when it is determined that the backup battery is completely recharged, then, the external power supply is used for operating the router device. In case of a power outage, the router is automatically operated by the backup battery.

In this manner, the backup battery integrated Wi-Fi router device of the present invention accomplishes all of the foregoing objectives and provides users with a router device that provides uninterrupted Wi-Fi connectivity during power outages. The built-in battery backup can sustain the router for up to 12 hours, ensuring that users remain connected even during prolonged power interruptions. The router device is particularly beneficial during emergencies such as storms or natural disasters, where maintaining communication and access to information is crucial. The device automatically charges the backup battery when the external power supply is available and transitions to battery power during an outage of the external power supply.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a Wi-Fi router device. The Wi-Fi router device further comprises an integrated backup battery located at the base of the device, the integrated backup battery is capable of providing up to 12 hours of Wi-Fi service without requiring an external power supply, wherein the backup battery is adapted to recharge using an external power supply.

In another aspect, a Wi-Fi router with an integrated backup battery is disclosed. The router includes a weatherproof and durable housing, a plurality of LAN ports adapted for wired connections, a heatsink to prevent overheating, an LED indicator adapted to flash in different colors based on the operational status of the device, the integrated backup battery is at least a 100 W Li-Ion battery, the integrated backup battery is capable of providing up to 12 hours of Wi-Fi service without requiring an external power supply.

In yet another embodiment, a method for providing Wi-Fi using a Wi-Fi router device in the absence of a power supply is disclosed. The method includes the steps of providing the Wi-Fi router device, the device includes a backup battery adapted to provide power to the device in the absence of the external power supply. The method further includes switching between using an integrated backup battery and an external power supply based on the availability of the external power supply, utilizing the integrated backup battery to power the device for up to 12 hours in the absence of an external power supply, and recharging the integrated backup battery using the external power supply when available.

In yet another embodiment, the router device includes a power supply module for converting AC power to DC power for device operation and battery recharging.

In a further embodiment, the router device further comprises a processor and memory components including RAM and flash memory for operating system and data packet processing.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the battery integrated Wi-Fi router device of the present invention in accordance with the disclosed architecture;

FIG. 2 illustrates a rear perspective view of the backup battery integrated Wi-Fi router device of the present invention in accordance with the disclosed structure;

FIG. 3 illustrates a block diagram showing additional electronic components included in the backup battery integrated Wi-Fi router device of the present invention in accordance with the disclosed structure;

FIG. 4 illustrates a flow chart depicting a process of functioning of the Wi-Fi router device of the present invention in accordance with the disclosed structure;

FIG. 5 illustrates another flow diagram depicting the role of the backup battery in supplying power for operation of the router device in accordance with the disclosed structure; and

FIG. 6 illustrates a perspective view showing Wi-Fi provided by the Wi-Fi router device of the present invention using the backup battery in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved Wi-Fi router device. There is also a long-felt need in the art for a router device that includes a backup battery for operation of the router device. Additionally, there is a long-felt need in the art for a novel Wi-Fi router device that can provide Wi-Fi internet through a standard power or a backup battery. Moreover, there is a long-felt need in the art for a novel Wi-Fi router that includes a backup battery which can be recharged using an external power supply. Furthermore, there is a long-felt need in the art for a Wi-Fi router device that includes an integrated battery to power the router device to maintain internet access. Also, there is a long-felt need in the art for a Wi-Fi router device that offers continuous Wi-Fi power, specifically during power outages. Finally, there is a long-felt need in the art for a Wi-Fi router device that features an internal battery backup that can maintain Wi-Fi access for up to 12 hours without requiring an external power supply.

The present invention, in one exemplary embodiment, is a Wi-Fi router with an integrated backup battery. The router includes a weatherproof and durable housing, a plurality of LAN ports adapted for wired connections, a heatsink to prevent overheating, an LED indicator adapted to flash in different colors based on the operational status of the device, the integrated backup battery is at least a 100 W Li-Ion battery, the integrated backup battery is capable of providing up to 12 hours of Wi-Fi service without requiring an external power supply. The integrated backup battery is automatically recharged when the external power supply is available.

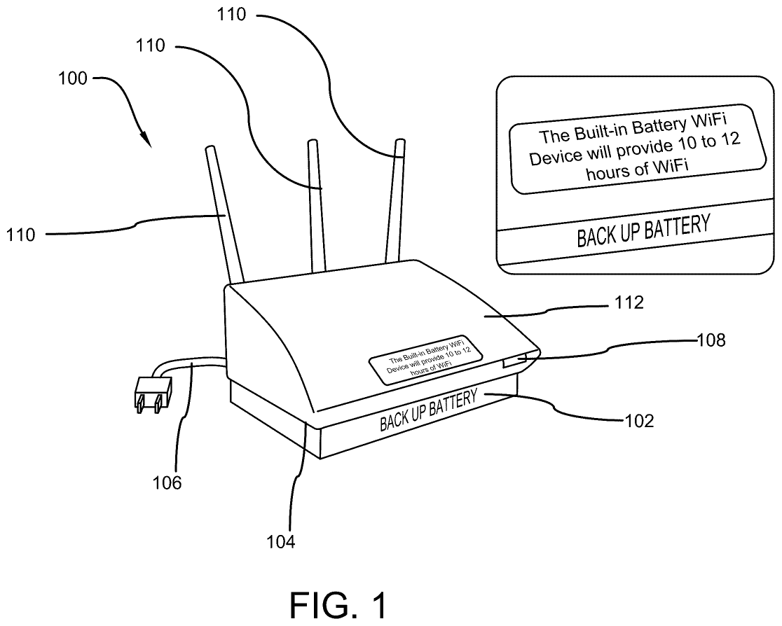

Referring initially to the drawings, FIG. 1 illustrates a perspective view of the battery integrated Wi-Fi router device of the present invention in accordance with the disclosed architecture. The battery integrated Wi-Fi router device 100 of the present invention is designed to have an integrated backup battery for operating the Wi-Fi router device 100 without requiring any external power supply for a period of time. More specifically, the Wi-Fi router device 100 is a Wi-Fi 6 router device and the backup battery 102 is integrated at the base 104 of the device 100. The backup battery 102 is preferably at least a 100 W battery and can provide Wi-Fi for up to 12 hours without requiring any external power supply. When the external power supply is available, the router device 100 can operate using the external power supply such as received through the power cord 106 from a wall mounted power plug.

A LED 108 flashes in a first color such as green color when the device 100 is activated and can flash in a second color such as red color when the device 100 does not work properly. The Wi-Fi router device 100 has a plurality of antennas 110 for sending and receiving radio signals. The antennas 110 support higher data rates and improve signal quality and can implement Multiple Input Multiple Output (MIMO).

The housing 112 of the router device 100 protects the internal electronic components of the router device 100 and is weatherproof and durable. The housing 112 is preferably made of plastic or any other similar material. The router device 100 can come in different shapes and the integrated battery 102 can also be installed in different positions depending on the design of the router device 100.

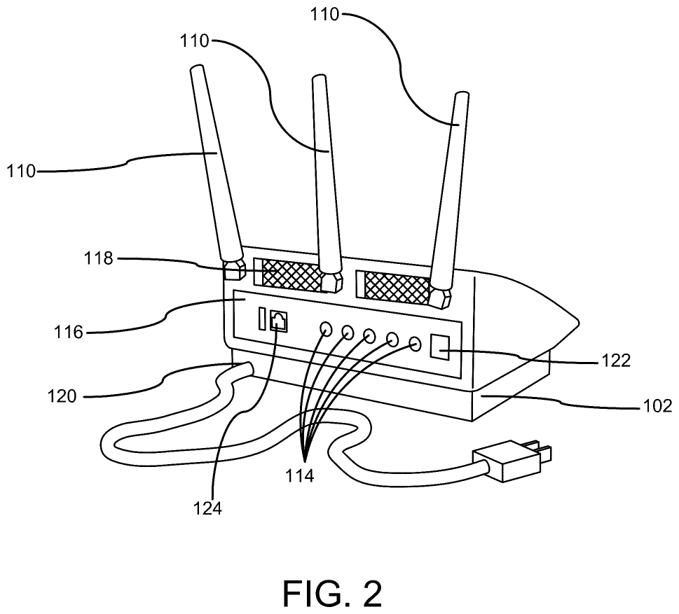

FIG. 2 illustrates a rear perspective view of the backup battery integrated Wi-Fi router device of the present invention in accordance with the disclosed structure. The power backup Wi-Fi router device 100 includes a plurality of LAN ports 114 on the rear surface 116 thereof. The LAN ports 114 are adapted to be used for wired connections to other devices such as laptops or computers. The LAN ports 114 can be gigabit LAN ports. A heatsink 118 of the router device 100 helps in preventing overheating and increases the operational life of the router device 100.

A power supply module 120 is configured to convert the AC power received from the external power supply through the power cord 106 into DC power which can be used for the functioning of the router device 100 and recharging of the backup battery 102. Preferably, the power supply module 120 is in the form of a compact AC to DC converter module. A power button 122 can be used for turning on and off the router device 100 and when the router device 100 is turned off, electrical power from the external power supply or the backup battery 102 is not used or retrieved for operation of the power backup Wi-Fi router device 100. A WAN port 124 is also included in the rear surface 116 of the housing 112.

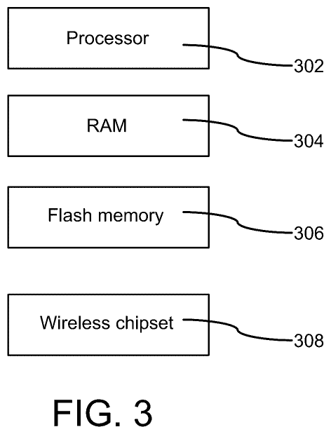

FIG. 3 illustrates a block diagram showing additional electronic components included in the backup battery integrated Wi-Fi router device of the present invention in accordance with the disclosed structure. The router device 100 includes a processor 302 which is adapted to run firmware of the device 100 and execute different network protocols supported by the device 100. The processor 302 can be an Application-Specific Integrated Circuit (ASIC) processor, SoC processor, single-core, or a multicore processor. A random access memory (RAM) 304 is used for storing the operating system, running applications, and buffering data packets during the processing of the packets. A flash memory 306 is included for storing firmware and settings of the router device 100. The content of the flash memory 306 is retained even when the power (from both external power supply and backup battery) is turned off.

A wireless chipset 308 is included in the device 100 for providing a wireless network to the connected devices. The wireless chipset 308 is adapted to convert data received from the internet into wireless signals and vice versa. The conversion enables devices such as smartphones, laptops, and tablets to connect to the internet wirelessly. Further, the wireless chipset 308 supports different Wi-Fi standards (like Wi-Fi 4, Wi-Fi 5, Wi-Fi 6, etc.) that have varying capabilities in terms of speed, range, and efficiency. Also, the wireless chipset 308 enables the router to operate on different frequency bands (like 2.4 GHz and 5 GHz).

In some embodiments, a modem is built-in in the router device 100 and in other embodiments, a modem is separately required for the functioning of the router device 100.

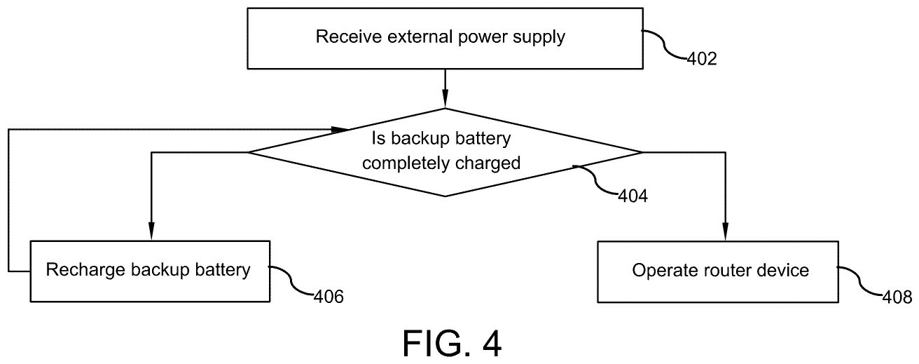

FIG. 4 illustrates a flow chart depicting a process of functioning of the Wi-Fi router device of the present invention in accordance with the disclosed structure. In the present embodiment, the router 100 receives an external power supply via the power cord 106 (Step 402) for operation of the router 100. Then, the processor 302 of the device 100 determines if the backup battery 102 is completely charged (Step 404). If it is determined that the backup battery 102 is not completely charged, then, the backup battery 102 is recharged using the external power supply (Step 406). In the preferred embodiment, the router device 100 operates on the backup battery 102 when the backup battery 102 is recharged using the external power supply. If the processor determines that the backup battery 102 is completely charged, then, the router device 100 is operated by the external power supply (Step 408) and a switch over to the backup battery 102 subsequently takes place upon unavailability of the external power supply.

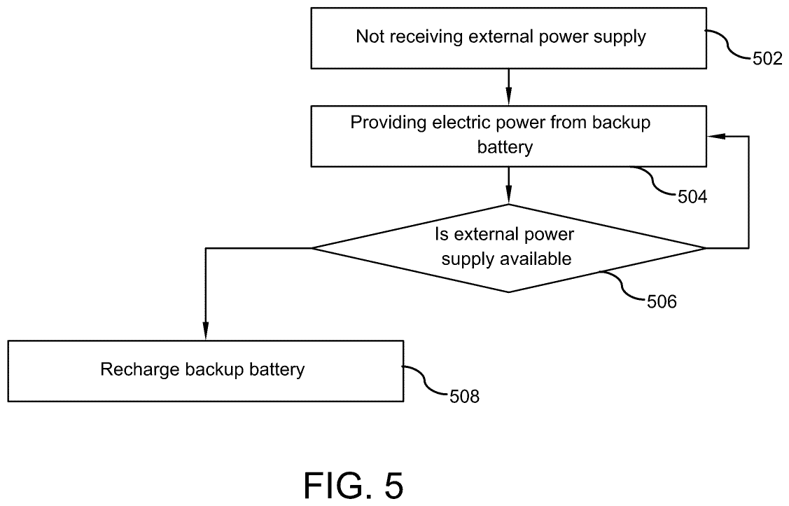

FIG. 5 illustrates another flow diagram depicting the role of the backup battery in supplying power for operation of the router device in accordance with the disclosed structure. Initially, the router device 100 does not receive the external power supply (Step 502). Then, the router device 100 is operated by the backup battery 102 integrated in the router device (Step 504). This is useful in storms and power outages or when the conventional power is not available for a period of time.

When the router device 100 is operated by the backup battery 102, then, the processor 302 determines if the external power is available (Step 506). If the external power is available, then, recharging of the backup battery is initiated (Step 508). If the external power is not available, then, the process of supplying power from the backup battery is continued.

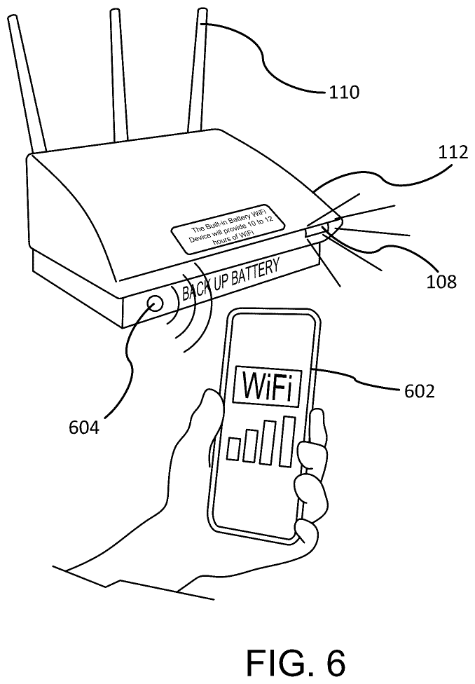

FIG. 6 illustrates a perspective view showing Wi-Fi provided by the Wi-Fi router device of the present invention using the backup battery in accordance with the disclosed structure. In the present embodiment, the external power supply is not available, and the router device 100 works on the backup battery 102. The illuminated LED 108 indicates the working of the router device 100 and any device such as a smartphone 602 can receive Wi-Fi 604 from the router device 100.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “battery integrated Wi-Fi router device”, “power backup Wi-Fi router device”, “Wi-Fi router device”, “device”, and “router device” are interchangeable and refer to the battery integrated Wi-Fi router device 100 of the present invention.

Notwithstanding the foregoing, the battery integrated Wi-Fi router device 100 of the present invention can be of any suitable configuration as is known in the art without affecting the overall concept of the invention, provided that it accomplishes the above-stated objectives. One of ordinary skill in the art will appreciate that the configuration and specification of the components of the battery integrated Wi-Fi router device 100 as shown in FIGS. is for illustrative purposes only, and that many other configurations of the battery integrated Wi-Fi router device 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery integrated Wi-Fi router device comprising;
a Wi-Fi router device having a connection to an external power supply, a backup battery integrated with said Wi-Fi router device, a power supply module, and a plurality of antennas for sending and receiving radio signals;
wherein said backup battery having at least a 100 W battery;
wherein said connection is a power cord;
wherein said Wi-Fi router device operates using said external power supply when a power supply is available through a wall mounted power plug and said power cord;
wherein said power supply module is an AC to DC converter module; and
further wherein said power supply module converts an AC power supply from said external power supply into DC power for functioning of said Wi-Fi router device and recharging of said backup battery.

2. The battery integrated Wi-Fi router device of claim 1, wherein said Wi-Fi router device having a power button for turning ON and OFF said Wi-F-router device and an LED for indicating a status of said Wi-Fi router device, and further wherein said LED flashes a first color for indicating a first activated status of said Wi-Fi router device.

3. The battery integrated Wi-Fi router device of claim 2, wherein said LED flashes a second color for indicating a second deactivated status of said Wi-Fi router device.

4. The battery integrated Wi-Fi router device of claim 3, wherein said Wi-Fi router device having a plurality of LAN ports for wired connections to other devices selected from the group consisting of a laptop and a computer.

5. The battery integrated Wi-Fi router device of claim 4, wherein said Wi-Fi router device having a weatherproof housing.

6. A method of powering a Wi-Fi router device, the method comprising the steps of:
providing a Wi-Fi router device having a connection to an external power supply, a backup battery integrated with said Wi-Fi router device, a power supply module, and a plurality of antennas for sending and receiving radio signals, wherein said backup battery having at least a 100 W battery, wherein said power supply module is an AC to DC converter module, further wherein said connection is a power cord;
operating said Wi-Fi router device with said external power supply when a power supply is available through a wall mounted power plug and said power cord;
operating said Wi-Fi router device with said backup battery when the power supply is not available through said wall mounted power plug and said power cord; and
converting an AC power supply from said external power supply into DC power for functioning of said Wi-Fi router device and recharging of said backup battery when the power supply is available.

7. The method of powering a Wi-Fi router device of claim 6 further comprising the step of operating said Wi-Fi router device with said backup battery when said backup battery is recharged from said external power supply.

8. The method of powering a Wi-Fi router device of claim 7 further comprising the step of operating said Wi-Fi router device with said external power supply when said processor detects said backup battery is completely charged.

9. The method of powering a Wi-Fi router device of claim 8 further comprising the step of switching to said backup battery when said external power supply is unavailable.

10. The method of powering a Wi-Fi router device of claim 9, wherein said Wi-Fi router device having a power button for turning ON and OFF said Wi-F-router device and an LED for indicating a status of said Wi-Fi router device, and further wherein said LED flashes a first color for indicating a first activated status of said Wi-Fi router device.

11. The method of powering a Wi-Fi router device of claim 10, wherein said LED flashes a second color for indicating a second deactivated status of said Wi-Fi router device.

12. The method of powering a Wi-Fi router device of claim 11, wherein said Wi-Fi router device having a plurality of LAN ports for wired connections to other devices selected from the group consisting of a laptop and a computer.

13. The method of powering a Wi-Fi router device of claim 12, wherein said Wi-Fi router device having a weatherproof housing.

14. A method of powering a Wi-Fi router device, the method comprising the steps of:
providing a Wi-Fi router device having a connection to an external power supply, a backup battery integrated with said Wi-Fi router device, a processor, and a power supply module, wherein said backup battery having at least a 100 W battery, wherein said power supply module is an AC to DC converter module, further wherein said connection is a power cord;
operating said Wi-Fi router device with said external power supply when a power supply is available through a wall mounted power plug and said power cord;
operating said Wi-Fi router device with said backup battery when the power supply is not available through said wall mounted power plug and said power cord;
determining with said processor if said backup battery is completely charged; and
recharging said backup battery with said external power supply if said backup battery is not completely charged.

15. The method of powering a Wi-Fi router device of claim 14 further comprising the step of operating said Wi-Fi router device with said backup battery when said backup battery is recharged from said external power supply.

16. The method of powering a Wi-Fi router device of claim 15 further comprising the step of operating said Wi-Fi router device with said external power supply when said processor detects said backup battery is completely charged.

17. The method of powering a Wi-Fi router device of claim 16 further comprising the step of: switching to said backup battery when said external power supply is unavailable.

18. The method of powering a Wi-Fi router device of claim 9, wherein said Wi-Fi router device having a power button for turning ON and OFF said Wi-F-router device and an LED for indicating a status of said Wi-Fi router device, and further wherein said LED flashes a first color for indicating a first activated status of said Wi-Fi router device.

19. The method of powering a Wi-Fi router device of claim 10, wherein said LED flashes a second color for indicating a second deactivated status of said Wi-Fi router device.

20. The method of powering a Wi-Fi router device of claim 11, wherein said Wi-Fi router device having a plurality of LAN ports for wired connections to other devices selected from the group consisting of a laptop and a computer.
